(19) United States
(12) Patent Application Publication
(10) Pub. No.: US 2012/0008974 A1
(43) Pub. Date: Jan. 12, 2012

(54) IMAGE FORMING APPARATUS

(75) Inventors: Tachio Kawai, Odawara-shi (JP); Tatsuya Suzuki, Kawasaki-shi (JP); Hideki Kakuta, Suntou-gun (JP)

(73) Assignee: CANON KABUSHIKI KAISHA, Tokyo (JP)

(21) Appl. No.: 13/179,848

(22) Filed: Jul. 11, 2011

(30) Foreign Application Priority Data
Jul. 12, 2010 (JP) 2010-157613
Jul. 8, 2011 (JP) 2011-151745

(51) Int. Cl. G03G 15/00; G03G 21/00

(52) U.S. Cl. 399/71; 399/350

(57) ABSTRACT

An image forming apparatus includes a rotatable image bearing member; a cleaning blade for removing toner in contact with the image bearing member; a load adjusting device for adjusting a contact load between the cleaning blade and the image bearing member; a developing roller for developing an electrostatic latent image on the image bearing member; a developing roller moving device for moving the developing roller between a developing position in which the electrostatic latent image is to be developed and a non-developing position retracted from the developing position; and a control device for effecting control such that the developing roller is moved from the developing position to the non-developing position by the developing roller moving device during rotation of the image bearing member and after an area on the image bearing member opposed to the developing roller at the time when the developing roller is started to be moved from the developing position to the non-developing position passes through a contact area between the cleaning blade and the image bearing member, the contact load is made smaller than that during development by the load adjusting device and then the rotation of the image bearing member is stopped.

### FIELD OF THE INVENTION AND RELATED ART

The present invention relates to an image forming apparatus such as a copying machine.

In a conventional image forming apparatus, transfer residual toner is scraped and removed from an image bearing member by using a cleaning blade having flexibility (rubber elasticity). The cleaning blade is contacted to the image bearing member, in order to improve a cleaning efficiency, counterdirectionally with a rotational direction of the image bearing member during image formation (Japanese Laid-Open Patent Application (JP-A) Hei 8-166751).

In this image forming apparatus, during rest of the image forming apparatus (during stop of rotation of the image bearing member), a residual matter with a small particle size, such as fine powdery toner or an external additive, which remains in a cleaning blade contact area of the image bearing member (in a nip area) is pressed against the surface of the image bearing member with a press-contact force. As a result, the residual matter is agglomerated and firmly fixed on the surface of the image bearing member, so that a sliding property (friction coefficient μ) in the nip A is changed in a state different from that in another area. Generally, the friction coefficient μ in the nip area is changed to a value which is lower than that in another area.

For that reason, at the instant when the image bearing member is driven again and rotated and thus is contacted again to the cleaning blade in the nip area with decreased friction, a rotational speed of the image bearing member becomes fast. In that case, at a portion when an electrostatic latent image is formed on the image bearing member by an exposure means, exposure is effected at a position deviated from an ideal exposure position depending on a fluctuation in speed, so that positional deviation of the electrostatic latent image occurs. Further, at a portion where a toner image formed on the image bearing member is transferred onto a transfer material, a speed of the image bearing member relative to the transfer material is changed depending on the fluctuation in speed, so that improper transfer such as density fluctuation or the like of the toner image to be transferred onto the transfer material occurs.

JP-A Sho 57-13471 and U.S. Pat. No. 7,120,376 have proposed a constitution in which the agglomeration of the residual matter in the nip area at the image bearing member surface by contact pressure of the cleaning blade is avoided. In JP-A Sho 57-13471, the cleaning blade is separated from the image bearing member during the rotation of the image bearing member after image formation and then this separated state is kept until a subsequent image forming operation is started. In U.S. Pat. No. 7,120,376, after the image bearing member is once stopped during completion of the image formation, the image bearing member is slightly rotated relative to the cleaning blade to remove the residual matter interposed in the nip area. Then, by reversely rotating the image bearing member, the agglomeration of the residual matter is avoided and distortion of the cleaning blade is released.

### SUMMARY OF THE INVENTION

The present invention is a result of further development of the above-described prior art.

A principal object of the present invention is to provide an image forming apparatus capable of suppressing positional deviation of an electrostatic latent image and improper transfer by avoiding agglomeration of a residual matter in a nip area at an image bearing member surface due to contact pressure of a cleaning blade.

Another object of the present invention is to provide an image forming apparatus capable of preventing stop of (rotation of) the image bearing member in a state in which unnecessary toner is transferred from a developing device onto the image bearing member, during cleaning blade contact pressure control, without being removed from the image bearing member surface.

A further, object of the present invention is to provide an image forming apparatus capable of suppressing scattering of the unnecessary toner inside the image forming apparatus to prevent contamination of the inside of the image forming apparatus with scattered toner.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a structural view of an image forming apparatus according to Embodiment 1 of the present invention.

Parts (a) and (b) of FIG. 2 are structural views each showing a cleaning device and a developing device in Embodiment 1.

FIG. 3 is a timing chart showing contact and separation between a cleaning blade and a developing roller.

FIG. 4 is a flow chart showing contact and separation of the cleaning blade with respect to an image bearing member in Embodiment 1.

FIG. 5 is a partial sectional view for illustrating a force acting on a cleaning blade of a cleaning device in Embodiment 2.

FIG. 6 is an exploded perspective view of the cleaning device in Embodiment 2.

### DESCRIPTION OF THE PREFERRED EMBODIMENTS

### Embodiment 1

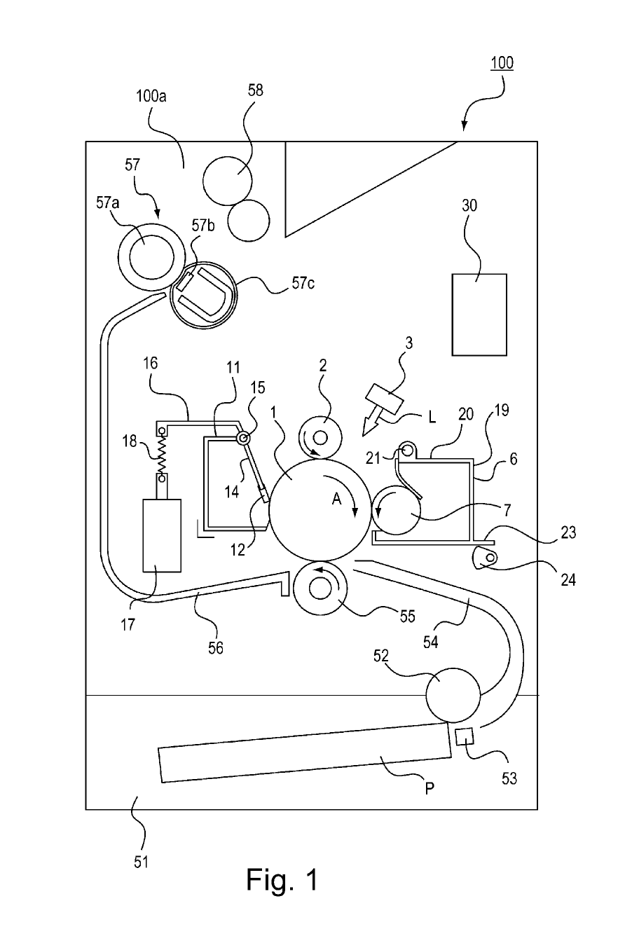

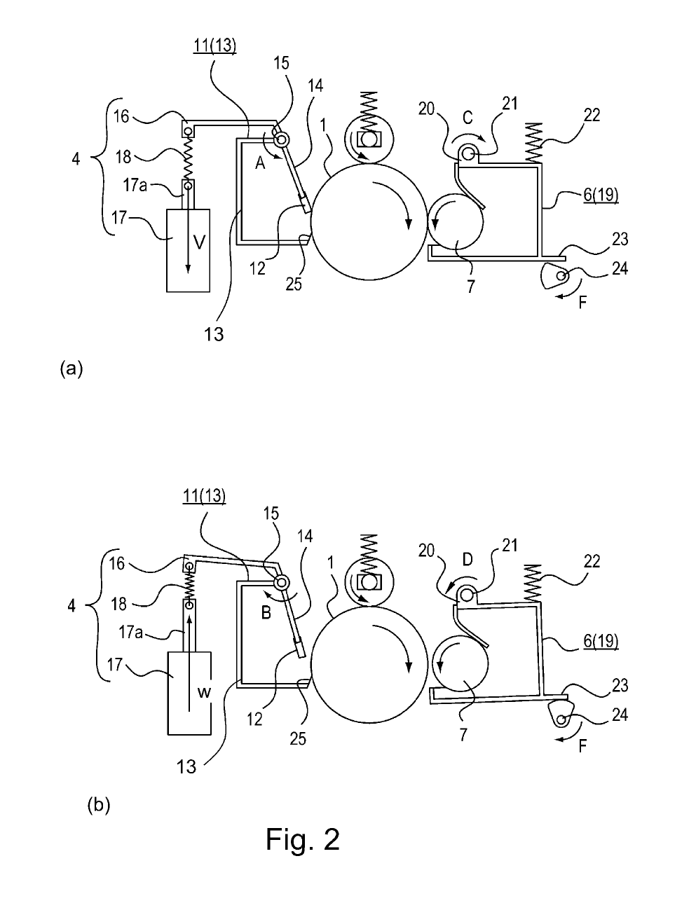

An embodiment of the image forming apparatus according to the present invention will be described with reference to the drawings. FIG. 1 is a structural view of an image forming apparatus 100 in this embodiment. As shown in FIG. 1, the image forming apparatus 100 includes an apparatus main assembly 100a communicatably connected with an external device such as a personal computer. Further, depending on image information from the external device, an image is formed on a recording material P (such as recording paper, OHP sheet or cloth) with a developer by an electrophotographic image forming process.

A photosensitive drum (image bearing member) 1 is uniformly charged to a negative potential of −600 V by a charging roller 2. The photosensitive drum 1 is irradiated with laser light L from an exposure device 3 depending on the image information to lower the negative potential to about −100 V at an exposed portion, so that an electrostatic latent image is formed. The electrostatic latent image is developed into a toner image with toner as the developer by a developing roller 7 of a developing device 6.

The toner includes one being liable to be positively charged and one being liable to be negatively charged (hereinafter referred to as positive toner and negative toner, respectively). In this embodiment, the negative toner is used and a developing bias of −300 V is applied to the developing roller 7 to effect reverse development.

Incidentally, in the image forming apparatus for effecting the reverse development such that the negative toner is used on the negatively charged photosensitive drum 1, a discharged portion of the electrostatic latent image on the surface of the photosensitive drum 1 constitutes an image portion, on which the toner is deposited. Further, in the image forming apparatus for effecting normal development such that the positive toner is used on the negatively charged photosensitive drum 1, a non-discharged portion of the electrostatic latent image on the surface of the photosensitive drum 1 constitutes an image portion, on which the toner is deposited. Thus, the electrostatic latent image on the photosensitive drum 1 is developed, so that the toner image is formed.

On the other hand, in synchronism with the toner image formation, the recording material P set in a feeding cassette 51 is separated and fed one by one by a pick-up roller 52 and a press-contact member 53 to be press-contacted to the pick-up roller 52. Then, the recording material P is conveyed along a conveying guide 54 to a transfer nip formed between a transfer roller 55 and the portion 1. At the transfer nip, the toner image formed on the photosensitive drum 1 (image bearing member) is transferred onto the recording material P, which passed through a conveying guide 56 to be conveyed to a fixing device 57. The fixing device 57 includes a driving roller 57a and a fixing roller 57c containing a heater 57b. The recording material P passes through a fixing nip, formed between the fixing roller 57c and the driving roller 57a, in which heat and pressure are applied, so that the toner image is fixed on the recording material P. The recording material P on which the toner image is fixed is discharged to the outside of the apparatus main assembly by a discharging roller pair 58.

After the toner image transfer, the photosensitive drum 1 on which residual toner is somewhat left rotates as it is and is subjected to cleaning by a cleaning blade 12 of a cleaning device 11, thus preparing for next image formation.

### (Cleaning Device 11)

Next, a load adjusting constitution of the cleaning blade 12 with respect to the photosensitive drum 1 will be described. Parts (a) and (b) of FIG. 2 are structural views showing the cleaning device 11 and the developing device 6 in this embodiment. In FIG. 2, the cleaning device 11 includes a cleaning device frame 13 having an opening at the photosensitive drum 1 side. The cleaning blade 12 is molded integrally with a blade holder 14. The blade holder 14 is rotatably supported about a supporting point 15 by the cleaning device frame 13.

Next, a load adjusting means 4 (load adjusting device) for adjusting a contact load of the cleaning blade 12 on the photosensitive drum 1 will be described. The load adjusting means 4 is constituted by a lever 16, a coil spring 18 and a solenoid 17.

The lever 16 is connected to the blade holder 14 at one end, and the blade holder 14 and the lever 16 are integrally rotated about the supporting point 15. The lever 16 is connected to the solenoid 17 via the coil spring 18.

As shown in (a) of FIG. 2, when the solenoid 17 is placed in ON state (energization state) by a controller 30 (control device or control means), a movable portion 17a of the solenoid 17 is moved and retracted in an arrow V direction. As a result, by an elastic force of the coil spring 18, the lever 16 and the blade holder 14 are rotated about the supporting point 15 (in an arrow A direction, so that the cleaning blade 12 is urged toward the photosensitive drum 1.

This state corresponds to a state when the cleaning blade 12 cleans the surface of the photosensitive drum 1 and in this state, the solenoid 17 pulls the coil spring 18 for bringing the cleaning blade 12 into press-contact to the photosensitive drum 1. The contact load of the cleaning blade 12 on the photosensitive drum 1 is adjusted to an optimum contact load for removing the residual toner deposited on the photosensitive drum 1.

The cleaning blade 12 is press-contacted to the photosensitive drum 1 at its one side edge. When the residual toner which is not completely transferred at the transfer portion reaches the edge, the residual toner is scraped (removed) by the cleaning blade 12. Further, at a lower portion of the cleaning device frame 13, a sealing sheet 25 is mounted so as to prevent the toner scraped by the cleaning blade 12 from being leaked out to the outside of the cleaning device frame 13.

As shown in (b) of FIG. 2, when the solenoid 17 is placed in OFF state (non-energization state) by the controller 30, the movable portion 17a of the solenoid 17 moves and projects in an arrow W direction. As a result, by the elastic force of the coil spring 18, the lever 16 and the blade holder 14 are rotated about the supporting point 15 (in an arrow B direction), so that the cleaning blade 12 is separated (spaced) from the photosensitive drum 1. At this time, the coil spring 18 has a natural length such that an urging force is not generated.

### (Developing Device 6)

Next, the control and separation of the developing roller 7 with respect to the photosensitive drum 1 will be described. In the image forming apparatus, in order to develop the electrostatic latent image on the photosensitive drum 1 into the toner image by the developing roller 7 during image formation (during development), the developing device 6 is located in a state in which the developing roller 7 and the photosensitive drum 1 are contacted to each other. Further, the cleaning blade 12 is press-controlled to the photosensitive drum 1 with the optimum contact load for removing the residual toner deposited on the photosensitive drum surface.

On the other hand, during non-image formation, the contact load of the cleaning blade 12 on the photosensitive drum 1 is made smaller than that during the image formation. This is because an occurrence of such a phenomenon that the photosensitive drum 1 is left standing for a long time in a rest state and a residual matter, such as fine powdery toner with a small particle size or an external additive, remaining in a cleaning blade contact area of the photosensitive drum 1 is pressed against the surface of the photosensitive drum 1 by the cleaning blade 12 to be agglomerated is prevented. Further, during the non-image formation, in order to prevent contamination of the photosensitive drum surface with the toner which is transferred from the developing device 6 onto the photosensitive drum 1 and is deposited on the photosensitive drum 1, the developing roller 7 is separated from the photosensitive drum 1.

As shown in FIG. 2, the developing device 6 includes a developing device frame 19, an arm portion 20, an urging spring 22, a spacing cam (developing device moving means or developing device moving device) 24. The arm portion 20 is rotatably supported about a supporting point 21 at its one end and is connected to an upper portion of the developing device frame 19 of the developing device 6 at the other end thereof. The arm portion 20 is urged at the other end in a direction (indicated by an arrow C) in which the developing roller 7 is contacted to the photosensitive drum 1 by the urging spring 22.

The developing device frame 19 includes a portion to be urged 23. During the image formation using the developing device 6, as shown in (a) of FIG. 2, the spacing cam 24 has been rotated at a position separated (spaced) from the portion to be urged 23. As a result, the arm portion 20 is urged by the urging spring 22 to be rotated about the supporting point 21, so that the developing roller 7 provided in the developing device frame 19 is moved to a position (developing position) in which the developing roller 7 is opposed and contacted to the photosensitive drum 1.

During the non-image formation for the developing device 6, as shown in (b) of FIG. 2, the spacing cam 24 is rotated in an arrow F direction to push up the portion to be urged 24. As a result, the developing device frame 19 and the arm portion 20 are rotated about the supporting point 21 in an arrow D direction against the urging force of the urging spring 22. As a result, the developing roller 7 is moved to a position (non-developing position) in which the developing roller 7 is retracted and separated from the photosensitive drum 1.

### (Contact and Separation of Cleaning Blade 12 and Movement of Developing Roller 7)

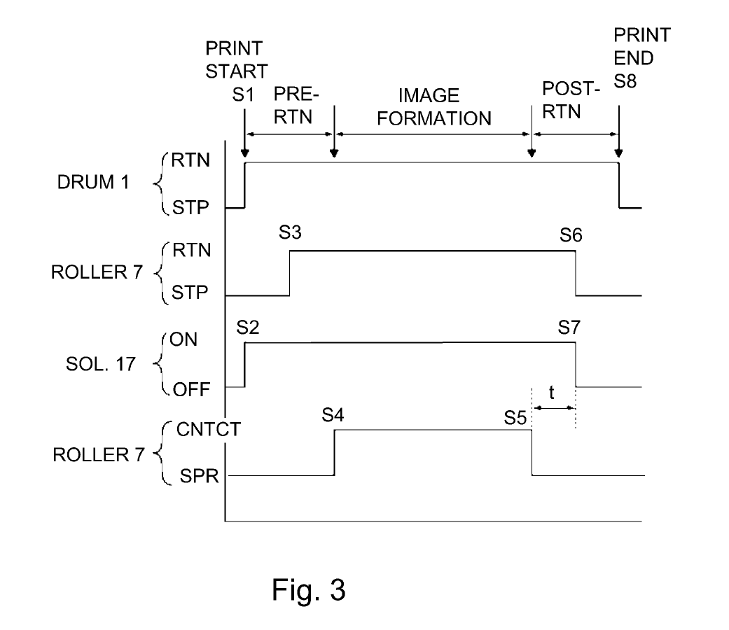

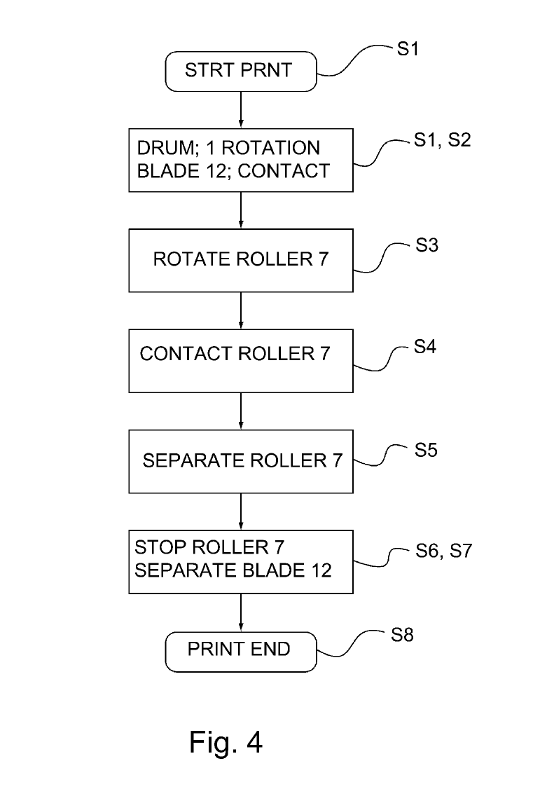

Next, the contact and separation of the cleaning blade 12 with respect to the photosensitive drum 1 and movement of the developing roller 7, during a period from print start of the image forming apparatus 100 to print end of the image forming apparatus 100, will be described. FIG. 3 is a timing chart for illustrating the contact and separation of the cleaning blade 12 with respect to the photosensitive drum 1 and the movement of the developing roller 7. FIG. 4 is a flow chart showing the contact and separation of the cleaning blade 12 with respect to the photosensitive drum 1 and the movement of the developing roller 7. During a period from the print start to (start of) the image formation, a rotating operation of the photosensitive drum 1 is referred to as pre-rotation. Further, during a period from the end of the image formation to the end of the printing operation, a rotating operation of the photosensitive drum 1 is referred to as post-rotation. Operations of the photosensitive drum 1, the developing roller 7, the solenoid 17 and the spacing cam 24 described below are controlled by the controller 30 (FIG. 1) constituted by CPU, ROM and the like.

Referring to FIG. 3, the printing operation is started in the image forming apparatus main assembly on the basis of a signal from the external device. Before the start of the printing operation, the solenoid 17 is turned off, so that the cleaning blade 12 is placed in the separated state from the photosensitive drum 1. Further, the spacing cam 24 urges the portion to be urged 23, so that the developing roller 7 is placed in the retracted state from the photosensitive drum 1.

When the printing operation is started, a driving source (not shown) is operated to start the rotation of the photosensitive drum 1 (S1). Nearly simultaneously with the rotation of the photosensitive drum 1, the solenoid 17 is turned on by the controller 30, so that the cleaning blade 12 is urged against the photosensitive drum 1 (S2).

Then, a driving source (not shown) is operated to start the rotation of the developing roller 7 (S3). Then, the spacing cam 24 is rotated to release the urging toward the portion to be urged 23, so that the developing roller 7 is moved to the developing position (S4). In synchronism with timing when the developing roller 7 is moved to the developing position, operations of the charging roller 2, the transfer roller 55, the exposure device 3 and the pick-up roller 52 are also started, so that the image formation is executed.

During the image formation, after the toner image transfer onto the recording material P, the toner and the like remaining on the surface of the photosensitive drum 1 are scraped off the surface of the photosensitive drum 1 by the cleaning blade 12. Then, the residual matter such as the toner with the small particle size or the external additive is gradually accumulated in the cleaning blade contact area (nip area) of the photosensitive drum 1.

When the final image formation (job) to be executed by the printing operation is ended (during the rotation of the photosensitive drum 1 after the end of the development), the spacing cam 24 is rotated to push up the portion to be urged 23 again, so that the developing roller 7 is moved to the non-developing position (S5). In synchronism with this timing, the operations of the charging roller 2, the transfer roller 55, the exposure device 3 and the pick-up roller 52 are also ended, so that the image formation is ended.

Then, the rotation of the developing roller 7 is stopped (S6). Nearly simultaneously with the stop of the rotation of the developing roller 7, the solenoid 17 is turned off, so that the cleaning blade 12 is separated from the photosensitive drum 1 (S7). Then, the printing operation is ended (S8).

As a result, the residual matter accumulated in the nip area is moved from the nip area with the rotation of the photosensitive drum 1. Therefore, it is possible to suppress sticking of the residual matter as the agglomerate on the photosensitive drum 1 due to the press-contact of the cleaning blade 12 against the photosensitive drum 1. As a result, a lowering in friction coefficient μm in the nip area of the photosensitive drum 1 can be suppressed to realize a constant rotational speed of the photosensitive drum 1, so that it is possible to suppress the positional deviation of the electrostatic latent image and the improper transfer such as the density fluctuation or the like of the toner image transferred onto the recording material P.

Further, the sticking of the residual matter does not occur and therefore an occurrence of a stripe or image blur (density fluctuation or the like) every (one) rotational period of the photosensitive drum 1 can be suppressed without performing the pre-rotation for a long time before the image formation.

Further, a time from timing when the movement of the developing roller 7 from the developing position to the non-developing position is completed to timing when the separation of the cleaning blade 12 is started is taken as t. Then, the time t is set at a value which is equal to or longer than a time until an area, on the photosensitive drum 1 in which the photosensitive drum 1 opposes the developing roller 7 at the time when the movement of the developing roller 7 from the developing position to the non-developing position, passes through the contact area in which the cleaning blade 12 is contacted to the photosensitive drum 1.

This is because the cleaning blade 12 is separated from the photosensitive drum 1 in view of toner supply from the developing roller 7 to the photosensitive drum 1.

In this embodiment, the developing roller 7 and the photosensitive drum 1 are contacted during the development, so that the development is effected. For that reason, even when a back contrast potential (a potential difference between the developing bias and a charge potential (at the non-image portion)) is provided so as not to supply the toner from the developing roller 7 to the non-image portion on the photosensitive drum 1 during the non-development, there is a possibility that the toner is mechanically supplied to the photosensitive drum 1.

Further, in this embodiment, the negative toner is used but the positive toner is also present in a very small amount. This positive toner is deposited as reversely charged fog toner on the non-image portion of the photosensitive drum 1 even when the back contrast potential is provided.

When the developing roller 7 is moved to the non-developing position in which the developing roller 7 is separated from the photosensitive drum 1, the toner supplied to the photosensitive drum 1 by the mechanical contact between the developing roller 7 and the photosensitive drum 1 is prevented. Further, the reversely charged fog toner is liable to be supplied with an increase in electric field between the developing roller 7 and the photosensitive drum 1. Therefore, when the developing roller 7 is far separated from the photosensitive drum 1, the electric field between the developing roller 7 and the photosensitive drum 1 is weaken and therefore the reversely charged fog toner is less liable to occur.

By setting the time t as described above, when the developing roller 7 is located at the developing position, the area of the photosensitive drum 1 opposing the developing roller 7 passes through the contact area of the cleaning blade 12. Therefore, even in the case where the toner is unintentionally supplied to the photosensitive drum 1 when the developing roller 7 is located at the developing position, the toner is removed by the cleaning blade 12. Further, after the developing roller 7 is moved from the developing position, i.e., after the developing roller 7 is placed in a state in which the toner is less liable to be supplied from the developing roller 7 to the photosensitive drum 1, the cleaning blade 12 is separated from the photosensitive drum 1.

Therefore, compared with the case where the cleaning blade 12 is separated in a state in which the developing roller 7 is always located at the contact pressure, the cleaning blade 12 can be separated in a state in which the amount of the toner on the photosensitive drum 1 is small.

Therefore, it is possible to suppress the contamination of the inside of the image forming apparatus with the toner, remaining on the photosensitive drum 1, scattered during the urging-release of the cleaning blade 12.

Incidentally, the time t may preferably be set at a value which is equal to or more than a time until the area on the surface of the photosensitive drum 1 opposing the developing roller 7 at the time when the movement of the developing roller 7 from the developing position to the non-developing position is completed passes through the contact area between the photosensitive drum 1 and the cleaning blade 12. This is because at the position in which the movement of the developing roller 7 to the non-developing position is completed, the fog toner is least liable to be supplied from the developing roller 7 to the photosensitive drum 1. That is, the developing roller 7 and the photosensitive drum 1 are in a state in which they are remotest from each other and therefore there is less possibility that the toner is moved from the developing roller 7 to the photosensitive drum 1 by gravitation or air flow or the like with the rotation of the develop 1. Further, even when the electric field is generated between the developing roller 7 and the photosensitive drum 1, the electric field is most weakened, so that there is less possibility that the toner is supplied from the developing roller 7 to the photosensitive drum 1 by the electric field.

Further, after the printing operation is ended, in a state in which the image forming apparatus is placed on standby for start of a next printing operation, the solenoid 17 is turned off. Therefore, the contact load of the cleaning blade 12 is adjusted in a state in which it is smaller than that during the development (i.e., is adjusted at zero in this embodiment since the cleaning blade 12 is separated from the photosensitive drum 1). Therefore, there is no need to select a material, for the cleaning blade 12, which is excellent in creep property and is expensive, so that a choice of the material is increased and thus cost of the cleaning blade 12 can be reduced. Further, even when such a low-cost material is selected, it is possible to maintain a cleaning performance for a long term.

Further, the contact load adjustment leading to the creep prevention of the cleaning blade 12 and the contact load adjustment for removing the residual matter are executed by the single load adjusting means 4. As a result, the structure of the image forming apparatus 100 can be made compact.

Incidentally, in this embodiment, the cleaning blade 12 is described in the example in which the cleaning blade 12 is separated (spaced) from the photosensitive drum 1. However, the present invention is not limited to such a constitution (example) but within a range in which the contact state between the cleaning blade 12 and the photosensitive drum 1 is maintained, the contact load of the cleaning blade 12 may also be made smaller than that during the toner removal to remove the residual matter in the nip area. As a result, it is possible to suppress that the toner removed from the surface of the photosensitive drum 1 by the cleaning blade 12 after the development is scattered from the cleaning device 11 into the image forming apparatus 100 by vibration, from the outside of the image forming apparatus 100, generated due to transportation or the like and thus the inside of the image forming apparatus 100 is contaminated with the scattered toner.

### Embodiment 2

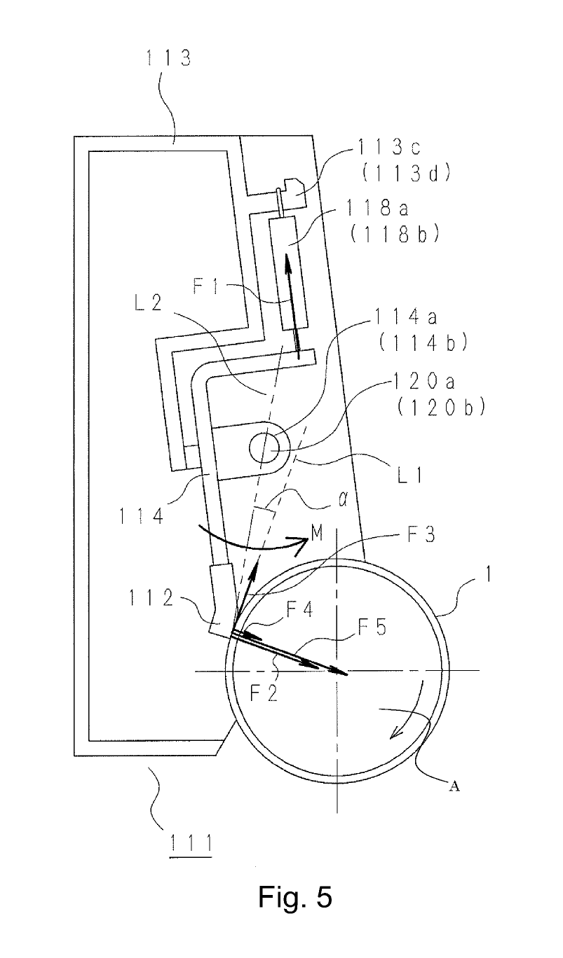

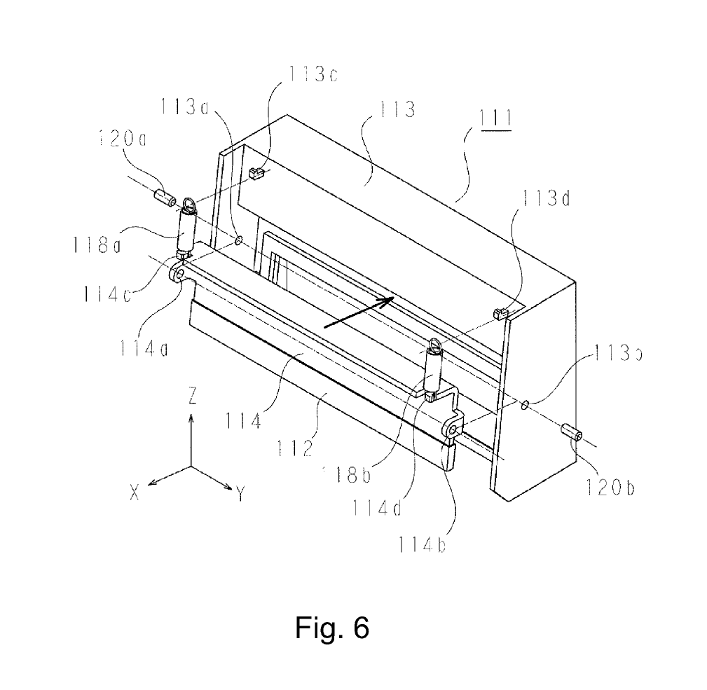

Next, a cleaning blade 112 supporting constitution of a cleaning device 111 and a contact load adjusting constitution of the cleaning blade 111 with respect to the photosensitive drum 1 will be described with reference to FIGS. 5 and 6.

A difference of a constitution of Embodiment 2 from that of Embodiment 1 is that the constitution of the mechanism for adjusting the contact load of the cleaning blade 112 on the photosensitive drum 1 is different from that in Embodiment 1. That is, the constitution of Embodiment 2 is, particularly, characterized by constitutions of the cleaning blade 112, a blade holder 114, a cleaning device frame 113 and coil springs 118 (118a, 118b). In this embodiment, a holding mechanism for holding the cleaning blade 112 so that a contact pressure of the cleaning blade 112 applied to the photosensitive drum 1 when the photosensitive drum 1 is rotated is larger than that when the rotation of the photosensitive drum 1 is stopped is provided. The holding mechanism includes the blade holder 114 for holding the cleaning blade 112 and the coil springs 118 and 118b which are an urging means (urging member) for urging the blade holder 114 in a direction in which the cleaning blade 112 is contacted to the photosensitive drum 1.

The cleaning blade 112 is disposed counter-directionally with the rotational direction of the photosensitive drum 1, and the blade holder 114 is provided rotatably about shafts 120a and 120b.

FIG. 5 is a structural view of the cleaning device 111 in this embodiment.

In this embodiment, the cleaning blade 112 is rotatably supported by a cleaning device frame 113 via the blade holder 114. A constitution for rotatably supporting the cleaning blade 112 will be described below.

As shown in FIG. 6, at end portions of the blade holder 114 with respect to a longitudinal direction (Y direction), holes to be supported 114a and 114b which are a rotation supporting point are provided. Further, the blade holder 114 is provided with hook portions 114c and 114d for permitting mounting of the coil springs 118a and 118b as the urging member for generating the contact pressure of the cleaning blade 112 to be applied to the photosensitive drum 1.

The blade holder 114 is supported by and connected to the cleaning device frame 113 so as to be rotatable about supporting portions 113a and 113b by the shafts 120a and 120b to be engaged with the holes to be supported 114a and 114b, respectively, and engaged with the supporting portions 113a and 113b, respectively, of the cleaning device frame 113.

Here, the holes to be supported 114a and 114b are, as shown in FIG. 5, disposed between an extension line of the blade holder 114 and a tangential line L1 on the photosensitive drum 1 at a point of intersection of the photosensitive drum 1 and the cleaning blade 112 on a projected cross-section of the holding mechanism with respect to the Y direction indicated in FIG. 6. In the projected cross-section, an angle formed between the tangential line L1 at the point of intersection of the photosensitive drum 1 and the cleaning blade 112 and a line L2 connecting the point of intersection of the photosensitive drum 1 and the cleaning blade 112 with the holes to be supported 114a and 114b is defined as an angle α.

The angle α is required to be 0 degrees or move in order to keep the cleaning blade 112 in a state in which the cleaning blade 112 always follows the drum surface. However, when the angle α is excessively large, the cleaning blade 112 is excessively pressed against the photosensitive drum 1, so that there is a possibility that rotational torque of the photosensitive drum 1 is excessively increased due to an increase in contact load of the cleaning blade 112 on the photosensitive drum 1.

Therefore, in this embodiment, the holes to be supported 114a and 114b are disposed so that the angle α is 0 degrees or more and 30 degrees or less.

Next, an urging constitution of the cleaning blade 112 against the photosensitive drum 1 will be described.

As shown in FIG. 6, in order to bring the cleaning blade 112 into contact to the photosensitive drum 1 via the blade holder 114, the coil springs 118a and 118b are mounted at the longitudinal (Y direction) end portions of the cleaning device 111.

In this embodiment, the coil springs 118a and 118b are a tension spring and are mounted between hook portions 113c and 113d provided on the cleaning device frame 113 and the hook portions 114c and 114d so as to provide a predetermined tension.

By a tension F1 of the coil springs 118a and 118b, as shown in FIG. 5, moment M is generated about the holes to be supported 114a and 114b with respect to the cleaning blade 112. By this moment M, the cleaning blade 112 is contacted to the photosensitive drum 1 uniformly with respect to the longitudinal direction.

Here, when the photosensitive drum 1 is in the rest state, as shown in FIG. 5, a contact pressure F2 at which the cleaning blade 112 is pressed against the photosensitive drum 1 in a predetermined amount by the moment M. Incidentally, in this embodiment, the contact pressure F2 is such a contact load that the residual matter, such as the fine powdery toner with the small particle size or the external additive, remaining on the develop surface is not agglomerated and stuck on the photosensitive drum surface in the nip area between the cleaning blade 112 and the photosensitive drum 1.

On the other hand, when the photosensitive drum 1 is in the rotation state, a thrust (penetration) force F4 is generated by a frictional force F3 generated between the cleaning blade 112 and the photosensitive drum 1 when the photosensitive drum 1 is rotated in an arrow A direction. Therefore, during the rotation of the photosensitive drum 1, a resultant force F5 of the above-described contact pressure F2 and the thrust force F4 based on the frictional force F3 acts as the contact load from the cleaning blade 112 toward the photosensitive drum 1.

Incidentally, in this embodiment, the resultant force F5 is an optimum contact load for removing the residual toner deposited on the surface of the photosensitive drum 1.

That is, the contact load of the cleaning blade 112 on the photosensitive drum 1 in the period from print start to print end of the image forming apparatus 100 is adjusted in the following manner. In the rest state of the photosensitive drum 1 before the printing operation is started, with respect to the cleaning blade 112 and the blade holder 114, the moment M about the holes to be supported 114a and 114b is generated by the tension F1 of the coil springs 118a and 118b. At this time, the cleaning blade 112 is contacted to the photosensitive drum 1 at the contact load equal to the contact pressure F2 generated by the moment M.

When the photosensitive drum 1 is rotated with the start of the printing operation, the cleaning blade 112 is contacted to the photosensitive drum 1 at the contact load equal to the resultant force F5 of the contact pressure F2 and the thrust force F4.

During the printing, i.e., during the rotation of the photosensitive drum 1, at the contact load equal to the resultant force F5, the state in which the cleaning blade 112 is contacted to the photosensitive drum 1 is maintained.

Then, when the printing operation is ended and the rotation of the photosensitive drum 1 is stopped, the frictional force F3 does not act between the cleaning blade 112 and the photosensitive drum 1, so that the thrust force disappears. In this state, the cleaning blade 112 is contacted to the photosensitive drum 1 again at the contact load equal to the contact pressure F2.

Further, the contact pressure F2 of the cleaning blade 112 applied to the photosensitive drum 1 was set at a load smaller than the contact load at which the residual matter, such as the fine powdery toner with the small particle size or the external additive, remaining on the photosensitive drum surface is agglomerated and stuck on the photosensitive drum surface.

Further, the resultant force F5 of the contact pressure F2 and the thrust force F4 was set at an optimum contact load for removing the residual toner deposited on the photosensitive drum surface during the rotation of the photosensitive drum 1. As a result, during the rest of the photosensitive drum 1 before the printing operation is executed, the contact load is kept in a low state in which only the contact pressure F2 is applied. Therefore, the residual matter such as the fine powdery toner with the small particle size or the external additive is not agglomerated and stuck on the photosensitive drum surface.

The printing operation will be described. When the photosensitive drum 1 is rotated with the execution of the printing operation, the thrust force F4 is added by the frictional force F3 between the cleaning blade 112 and the photosensitive drum 1, so that the contact load of the cleaning blade 112 is increased. Thus, in the state in which the photosensitive drum 1 is rotated, the developing roller 7 is moved from the developing position to the non-developing position to effect the image formation. Here, even when unnecessary fog toner supplied from the developing roller 7 to the photosensitive drum 1 surface or the toner remaining after the transfer is generated, the contact load of the cleaning blade 112 is in the increased state and therefore the toner is removed from the surface of the photosensitive drum 1 by the cleaning blade 112 with reliability. Incidentally, during a period in which the developing roller 7 is located at the developing position in order to form the image, the state in which the surface of the photosensitive drum 1 can be cleaned by the cleaning blade 112 is maintained.

Then, when final image formation to be executed by the printing operation is ended and then the developing roller 8 is moved from the developing position to the non-developing position, the unnecessary fog toner is less liable to be supplied from the developing roller 7 to the surface of the photosensitive drum 1. Thereafter, the rotation of the photosensitive drum 1 is stopped.

Specifically, the rotation of the photosensitive drum 1 is stopped after an area, on the photosensitive drum 1 in which the photosensitive drum 1 opposes the developing roller 7 at the time when the movement of the developing roller 78 from the developing position to the non-developing position, passes through the contact area in which the cleaning blade 12 is contacted to the photosensitive drum 1. Incidentally, similarly as in Embodiment 1, the rotation of the photosensitive drum 1 may preferably be stopped after the area on the surface of the photosensitive drum 1 opposing the developing roller 7 at the time when the movement of the developing roller 7 from the developing position to the non-developing position is completed passes through the contact area between the photosensitive drum 1 and the cleaning blade 112.

Similarly as before the printing operation is executed, there is no need to clean the surface of the photosensitive drum 1 after the stop of the rotation of the photosensitive drum 1, so that the cleaning blade 112 can be contacted to the photosensitive drum 1 at the small contact load equal to the contact pressure F2 alone.

Therefore, there is no need to select a material, for the cleaning blade 112, which is excellent in creep property and is expensive, so that a choice of the material is increased and thus cost of the cleaning blade 12 can be reduced. Further, even when such a low-cost material is selected, it is possible to maintain a cleaning performance for a long term.

Further, the contact load adjustment leading to the creep prevention of the cleaning blade 112 and the contact load adjustment for removing the residual matter are executed by using the frictional force generated between the cleaning blade 112 and the photosensitive drum 1 when the photosensitive drum 1 is rotated. As a result, the load adjustment is performed in the constitution which has already been employed and therefore there is no need to newly provide a dedicated load adjusting means, so that the structure of the image forming apparatus 100 can be made simple and compact.

A constitution in which the blade holder 114 is rotatably provided so as to urge the cleaning blade 112 with the metal-made coil spring 118 is employed, so that a designed value of the contact pressure between the cleaning blade 112 and the photosensitive drum 1 can be made smaller than that in the case where the cleaning blade is fixedly provided. In the case where the cleaning blade is fixedly provided, the contact pressure is determined by an elastic force of the cleaning blade 112. This elastic force largely depends on the environment and therefore a fluctuation of the contact pressure is large. For that reason, in order that the cleaning can be performed even in such an environment that the contact pressure is weaken, there is a need to set the position and angle of the blade so as to increase the contact pressure to some extent. On the other hand, in the case of employing the constitution in which the blade holder 114 is rotatably provided so as to urge the cleaning blade 112 with the coil spring 118, the contact pressure is principally determined by an urging force of the coil spring 118. The urging force does not so depend on the environment and therefore the fluctuation of the contact pressure is small. For that reason, there is no need to increase the contact pressure more than necessary. For that reason, in the case of employing the constitution in which the blade holder 114 is rotatably provided so as to urge the cleaning blade 112 with the coil spring 118, the contact pressure can be set at a value smaller than that in the case where the cleaning blade is fixedly provided. Therefore, it is possible to more reliably suppress the phenomenon such that the residual matter with a small particle size, such as fine powdery toner or the external additive, is agglomerated and then is stuck on the photosensitive member surface.

### Another Modified Embodiment

In Embodiments 1 and 2, the constitution in which the developing roller 7 is contacted to the photosensitive drum 1 at the developing position and is separated from the photosensitive drum 1 at the non-developing position is described. Other than this constitution, it is also possible to employ a constitution in which the developing roller 7 is in non-contact to the photosensitive drum 1 at the developing position and is located at a position, as the non-developing position, in which the developing roller 7 is retracted from the photosensitive drum 1 more than the developing position. That is, the position (non-developing position) of the developing roller 7 may be the retracted position from the photosensitive drum 1 more than the developing position.

While the invention has been described with reference to the structures disclosed herein, it is not confined to the details set forth and this application is intended to cover such modifications or changes as may come within the purpose of the improvements or the scope of the following claims.

This application claims priority from Japanese Patent Applications Nos. 157613/2010 filed Jul. 12, 2010 and 151745/2011 filed Jul. 8, 2011, which are hereby incorporated by reference.

What is claimed is:

1. An image forming apparatus comprising:
a rotatable image bearing member;
a cleaning blade for removing toner in contact with said image bearing member;
a load adjusting device for adjusting a contact load between said cleaning blade and said image bearing member;
a developing roller for developing an electrostatic latent image on said image bearing member;
a developing roller moving device for moving said developing roller between a developing position in which the electrostatic latent image is to be developed and a non-developing position retracted from the developing position; and
a control device for effecting control such that said developing roller is moved from the developing position to the non-developing position by said developing roller moving device during rotation of said image bearing member and after an area on said image bearing member opposed to said developing roller at the time when said developing roller is started to be moved from the developing position to the non-developing position passes through a contact area between said cleaning blade and said image bearing member, the contact load is made smaller than that during development by said load adjusting device and then the rotation of said image bearing member is stopped.

2. An image forming apparatus according to claim 1, wherein the contact load is made smaller than that during development by said load adjusting device by separating said cleaning blade from said image bearing member.

3. An image forming apparatus comprising:
a rotatable image bearing member;
a cleaning blade for removing toner in contact with said image bearing member;
a load adjusting device for adjusting a contact load between said cleaning blade and said image bearing member;
a developing roller for developing an electrostatic latent image on said image bearing member;
a developing roller moving device for moving said developing roller between a developing position in which the electrostatic latent image is to be developed and a non-developing position retracted from the developing position; and
a control device for effecting control such that said developing roller is moved from the developing position to the non-developing position by said developing roller moving device during rotation of said image bearing member and after an area on said image bearing member opposed to said developing roller at the time when said developing roller is completed to be moved from the developing position to the non-developing position passes through a contact area between said cleaning blade and said image bearing member, the contact load is made smaller than that during development by said load adjusting device and then the rotation of said image bearing member is stopped.

4. An image forming apparatus according to claim 3, wherein the contact load is made smaller than that during development by said load adjusting device by separating said cleaning blade from said image bearing member.

5. An image forming apparatus comprising:
a rotatable image bearing member;
a cleaning blade for removing toner in contact with said image bearing member;
a blade holder, swingably provided, for holding said cleaning blade;
an urging member for urging said blade holder in a direction in which said cleaning blade is contacted to said image bearing member;
a developing roller for developing an electrostatic latent image on said image bearing member;
a developing roller moving device for moving said developing roller between a developing position in which the electrostatic latent image is to be developed and a non-developing position retracted from the developing position; and
a control device for effecting control such that said developing roller is moved from the developing position to the non-developing position by said developing roller moving device during rotation of said image bearing member and after an area on said image bearing member opposed to said developing roller at the time when said developing roller is started to be moved from the developing position to the non-developing position passes through a contact area between said cleaning blade and said image bearing member, the rotation of said image bearing member is stopped.

6. An image forming apparatus according to claim 5, wherein said cleaning blade is provided counterdirectionally with a rotational direction of said image bearing member,
wherein said blade holder is provided swingably about a shaft, and
wherein when a projected cross-section of said holding mechanism is viewed from a longitudinal direction of said cleaning blade, said shaft is disposed in an area between said blade holder and a tangential line of said image bearing member at a position in which said cleaning blade is contacted to said image bearing member.

7. An image forming apparatus according to claim 6, wherein when the tangential line and a rectilinear line drawn from the position in which said cleaning blade is contacted to said image bearing member to the shaft is an angle α, the angle α is 0 degrees or more and 30 degrees or less.

8. An image forming apparatus comprising:
a rotatable image bearing member;
a cleaning blade for removing toner in contact with said image bearing member;
a blade holder, swingably provided, for holding said cleaning blade;
an urging member for urging said blade holder in a direction in which said cleaning blade is contacted to said image bearing member;
a developing roller for developing an electrostatic latent image on said image bearing member;
a developing roller moving device for moving said developing roller between a developing position in which the electrostatic latent image is to be developed and a non-developing position retracted from the developing position; and
a control device for effecting control such that said developing roller is moved from the developing position to the non-developing position by said developing roller moving device during rotation of said image bearing member and after an area on said image bearing member opposed to said developing roller at the time when said developing roller is completed to be moved from the developing position to the non-developing position passes through a contact area between said cleaning blade and said image bearing member, the rotation of said image bearing member is stopped.

9. An image forming apparatus according to claim 8, wherein said cleaning blade is provided counterdirectionally with a rotational direction of said image bearing member,
wherein said blade holder is provided swingably about a shaft, and
wherein when a projected cross-section of said holding mechanism is viewed from a longitudinal direction of said cleaning blade, said shaft is disposed in an area between said blade holder and a tangential line of said image bearing member at a position in which said cleaning blade is contacted to said image bearing member.

10. An image forming apparatus according to claim 9, wherein when the tangential line and a rectilinear line drawn from the position in which said cleaning blade is contacted to said image bearing member to the shaft is an angle α, the angle α is 0 degrees or more and 30 degrees or less.
